(19) United States
(12) Patent Application Publication
(10) Pub. No.: US 2014/0346101 A1
(43) Pub. Date: Nov. 27, 2014

(54) LATERALLY PERFUSED CHROMATOGRAPHY ELEMENT

(71) Applicant: ROBERT BOSCH GMBH, Stuttgart (DE)

(72) Inventor: Peter Rothacher, Bruchsal (DE)

(21) Appl. No.: 14/236,293

(22) PCT Filed: Jun. 15, 2012
(86) PCT No.: PCT/EP2012/061402

§ 371 Date: May 20, 2014

(30) Foreign Application Priority Data
Aug. 5, 2011 (DE) 10 2011 080 527.3

(51) Int. Cl. G01N 30/60; G01N 30/96; G01N 30/56

(52) U.S. Cl. CPC G01N 30/6095; G01N 30/56; G01N 30/96; G01N 2030/562
USPC 210/198.2

(57) ABSTRACT

A microfluidic chromatography element in which all components are situated in one plane and the mobile phase perfuses the stationary phase laterally.

### FIELD OF THE INVENTION

The present invention relates to a microfluidic chromatography element and its use in microfluidic systems.

### BACKGROUND INFORMATION

During the last several years, microfluidic systems have increasingly become established in chemical, biochemical and medical research and diagnostics. In the process, so-called micro total analysis systems (μTAS) offer the advantage that individual work steps may be combined, automated and simultaneously reduced to a micro-scale.

The polymerase chain reaction (PCR) has become established as an inherent part of biochemical investigations and allows the amplification of nucleic acids so as to make them accessible in detectable quantities. In many processes, it is necessary to purify the DNA which is to be amplified or has been amplified. For this purpose, various products are currently offered, for example, as kits or filter systems. Common to these products is the chromatographic principle under which the contaminant-containing solution including the sought for nucleic acid, which is also referred to as a mobile phase, is directed across a stationary solid phase, on which the nucleic acid is adsorbed. Using various solutions, less well adsorbed contaminants are subsequently eluted. Subsequently, the nucleic acid is eluted in a targeted manner using an additional mobile phase.

For this purpose, silica fibers, silica gel, aluminum oxide fibers, aluminum oxide gel or anion exchangers are used as stationary phases. In the case of anion exchangers, concentrated salt solutions are used for elution. For that reason, primarily silica fiber columns, through which the mobile phases are moved using centrifugation, have become established.

United States patent document US 2008/0277356 discusses a microfluidic device which functions according to the chromatographic principle. For this purpose, a channel structure for the mobile phase is placed in layers above a filter layer, so that a transversely perfused filter element results from the multilayer structure. A similar multilayer, transversely perfused filter structure is in US 2002/0185431. In the device made up of multiple layers according to WO 2004/065010, a membrane filter is used. The connection in series of multiple stationary phases as separate sections is also, for example, in EP 1916522.

### SUMMARY OF THE INVENTION

An object of the present invention is thus a microfluidic chromatography element having the following components:
a filling opening for filling with a stationary phase,
a cavity adjoining the filling opening for accommodating the stationary phase,
at least one fluid inlet for a mobile phase,
at least one fluid outlet for fractions of the mobile phase,
retaining structures for the stationary phase situated in the fluid inlet and fluid outlet,
   all components being situated in one plane and the mobile phase perfusing the stationary phase laterally.

This translates the method into a corresponding system, which may be integrated into a flat microfluidic biochip.

The phase which interacts with the individual substances of the substance mixture, i.e., the mobile phase, is referred to as the stationary phase. Conversely, the fluidic substance mixture, which perfuses the stationary phase, is referred to as the mobile phase.

In this connection, situated in one plane means that all components of the microfluidic chromatography element are situated next to one another and not in different layers. Since the inlets and outlets of the mobile phase as well as the intervening stationary phase are also included in this, the mobile phase perfuses the stationary phase laterally and not transversely. Through holes and additional fluidic levels, which are necessary in transversely perfused elements, may thus be omitted.

In one specific embodiment of the microfluidic chromatography element, the components are situated in one plane of a structured element. The structured element is made up in particular of a molded plastic part structured with the aid of injection molding, milling, deep-drawing or hot-stamping. Various polymers which may be thermoformed or pressed and which are inert to different stationary and mobile phases may be used for this purpose. Since the structured element is also used in microfluidic lab-on-chip systems, the element per se may be referred to as a chip.

In another specific embodiment, the structured element of the microfluidic chromatography element has a flat seated, tight fitting cover. The latter may be made from the same material as the structured element. Alternatively, however, a one-piece configuration of the microfluidic chromatography element is also possible.

The microfluidic chromatography element also has retaining structures, which in one particular specific embodiment have teeth, gaps, slots, pores and/or perforations, the openings of which are smaller than the smallest particles of the stationary phase. As the name implies, the function of the retaining structures is the reliable retention of particles of the stationary phase with respect to the inlet and the outlet of the mobile phase. Thus, the retention structures must be adapted depending on the filling of the stationary phase. The retention structures are located in the fluid inlet and the fluid outlet to the stationary phase. As such, they maybe of identical or different configuration, provided that the particles of the stationary phase may be reliably retained in the inlet and in the outlet of the mobile phase. Different particulate components are suitable as the stationary phase. Components having a particle diameter of 20 μm to 60 μm, for example, Silica Gel 60 from Merck, may be used. The retaining structures accordingly have smaller gaps. Thus, in the case of Silica Gel 60 as the stationary phase, the retaining structures have gaps of about 50 μm.

In one particular specific embodiment, the retaining structures are micro-milled, stamped, injection-molded, ablated from polymers with the aid of a laser or 3D-lithographed, rendered porous or are porous. In this case, the retaining structure may be formed from the same material as the structured element or from a different material, which is connected to the structured element.

In principle, any material, which is known as a particulate filling for the chromatographic separation, purification and/or identification as well as for ion exchange processes and may be applied to laterally perfused microfluidic systems, is suitable for the stationary phase.

In one specific embodiment, the stationary phase of the microfluidic chromatography element is selected from inorganic materials, which may be silicon dioxide, aluminum oxide, titanium oxide or zeolite and is present in the form of particles, powder, gel, fibers and/or pellets having an angle of repose adapted to the boundaries of the cavity.

In another specific embodiment, the stationary phase of the microfluidic chromatography element is selected from organic materials, which may be biopolymers, cross-linked agaroses may be used in particular, and is present in the form of particles, powder, gel, fibers and/or pellets having an angle of repose adapted to the boundaries of the cavity.

In another specific embodiment of the microfluidic chromatography element biochemical components, which may be recombinant libraries of antibodies, enzymes or proteins presented on the surface of bacteriophages are coupled to the stationary phase and are thus immobilized.

The angle of repose of the stationary phase is understood to be the angle up to which the particulate material of the stationary phase may be loaded, without slipping or collapsing. The angle of repose depends on the specific properties of the material of the stationary phase, in particular the type, cohesiveness, polarity, humidity, etc. As already mentioned, the boundaries of the cavity in the microfluidic chromatography element are adapted to the angle of repose of the stationary phase. This means, conversely, that the dimensions of the cavity must be taken into account in the selection of the stationary phase. With the aid of the angle which is formed by the boundary of the cavity and the cross section through the filling opening, this angle is in the ideal case equal to the angle of repose of the stationary phase. Therefore, in a specific embodiment, the angle formed by the boundary of the cavity and the cross section of the filling opening is larger than or equal to the angle of repose of the stationary phase. The filled cavity is then the actual chromatographic column.

In another specific embodiment of the microfluidic chromatography element, the filling opening for the stationary phase is formed in relation to the cavity, i.e., the actual chromatographic column, as a short channel structure. This prevents an unperfused large dead volume from being formed during the intended use. Also in this context, it is important that the angle which is formed by the boundary of the column and the cross section of the filling opening may not be flatter than the angle of repose of the stationary phase, or the dimensions of the cavity must be adjusted accordingly. The opening must, at least during filling with the stationary phase, point upwards, so that the particles may pass into the cavity of the column unhindered. For filling with the stationary phase, the chromatography element may be placed on edge or inclined. Optionally, during the filling process, the fill may be compacted with the aid of vibrations or percussions, making it possible for stationary phases to also have an angle of repose which is flatter than the angle formed between the boundary of the cavity and the cross section of the filling opening. Using these techniques makes it possible to produce very tightly packed columns without dead volumes or bypasses, which in turn results in enormous cost savings, since heretofore it has not been possible to use cost-effective particle beds in microfluidic systems. This also makes it possible to omit substantially more expensive magnetic particles (magnetic beads).

In another specific embodiment, the filling opening is sealed after filling by adhesive bonding, which may be done using adhesive film, hot-melt adhesive or liquid adhesive, heat-sealing, which may be done using a hot stamp, laser welding, or a mechanical sealing arrangement, which may be done using a plug or a stopper. Thus, the filling is no longer able to move during transport of the chip.

The simple integration of the microfluidic chromatography element makes it suitable for many applications. However, the use in pressure-driven or centrifugally driven microfluidic systems, in particular micro total analysis systems, is at the forefront, the primary focus being on purification, separation and/or the use in ion exchange processes. Use is primarily in the overpressure range from a few millibars to approximately half a bar. Other specific uses are in the development of lab-on-chip systems, e.g., for identification or resistance determination of bacteria, for biochemical separation and/or purification, or more generally in the development of healthcare and diagnostic products.

Other advantages and advantageous embodiments of the device according to the present invention are illustrated by the drawings and explained in the following description. It should be noted that the drawings have only a descriptive nature and are not intended to limit the present invention in any form.

### BRIEF DESCRIPTION OF THE DRAWINGS

FIG. 1 shows a schematic outline of a microfluidic chromatography element 1.

FIGS. 2A, 2B and 2C schematically show the principle and three different alternatives in the configuration of microfluidic chromatography element 1.

FIG. 3 shows a schematic representation of the filling of a chromatography element 1 standing on its side.

### DETAILED DESCRIPTION

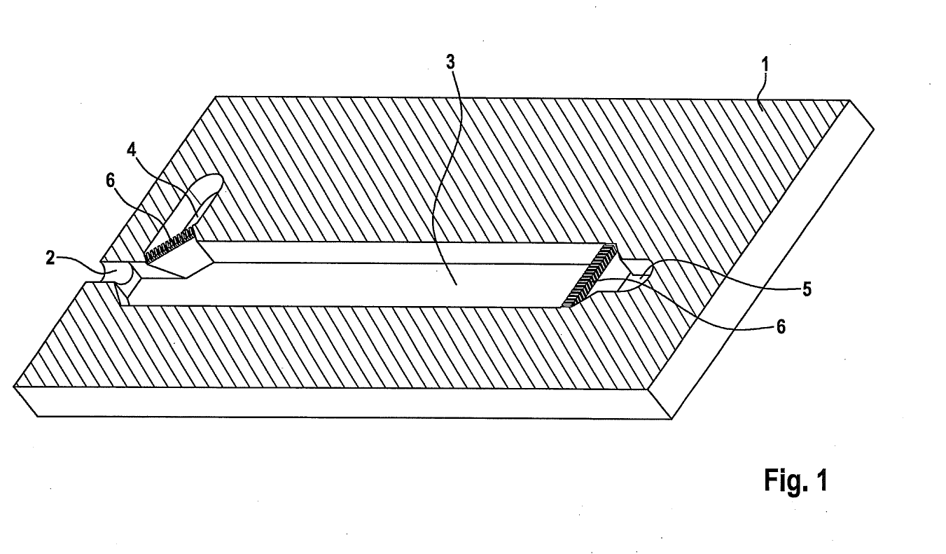

FIG. 1 shows a schematic outline of a microfluidic chromatography element 1. A filling opening 2 is adjoined by a cavity 3 for accommodating a stationary phase. A fluid inlet 4 of the mobile phase is delimited from cavity 3 by a first retaining structure 6. Cavity 3 is adjoined by a fluid outlet 5, which is also delimited from cavity 3 by a second retaining structure 6. All components for accommodating the mobile and the stationary phase are in one plane, which is only interrupted by retaining structures 6.

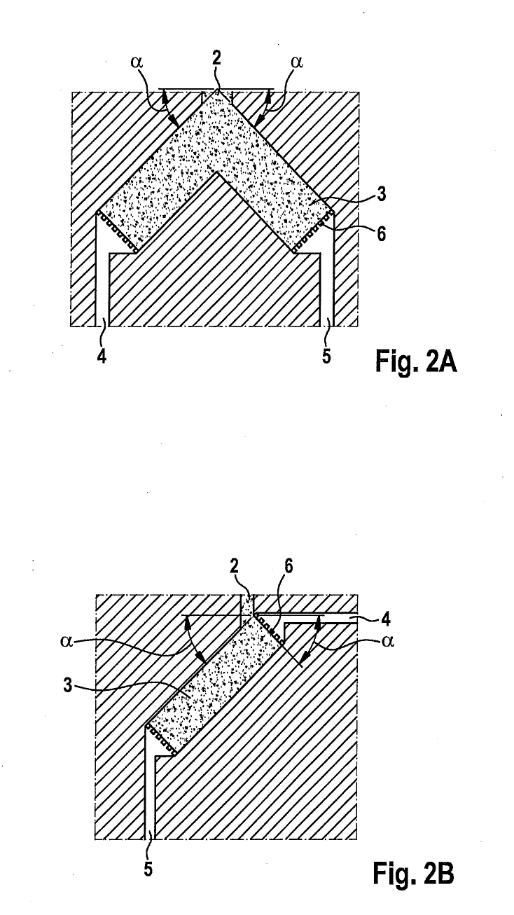

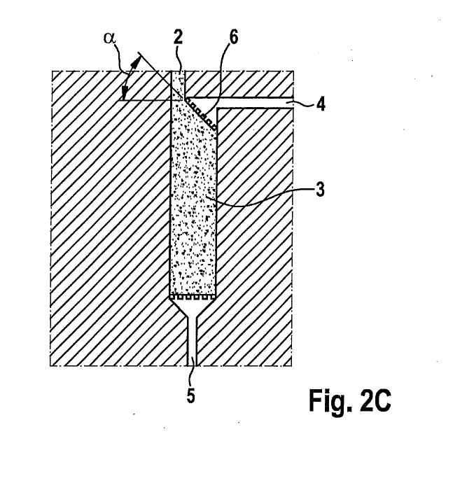

FIGS. 2A, B and C schematically show the principle and three different alternatives in the configuration of microfluidic chromatography element 1. Cavity 3 is filled with a fill via filling opening 2. Fluid inlet 4 and fluid outlet 5 are delimited from cavity 3 by retaining structures 6. An angle α, which is enclosed by the boundary of cavity 3 and the cross section through filling opening 2, illustrates the orientation of the upward pointing boundary of the column during the filling. In FIG. 2A, this boundary of cavity 3 is provided by the wall of the column. In FIG. 2B, this boundary is defined on the one hand by the wall of the column and on the other hand by retaining structure 6. In FIG. 2C, retaining structure 6 delimits cavity 3. The structure of microfluidic chromatography element 1 is configured in such a way that angle α is adapted to the angle of repose of the stationary phase in such a way that angle α is larger than or equal to the angle of repose.

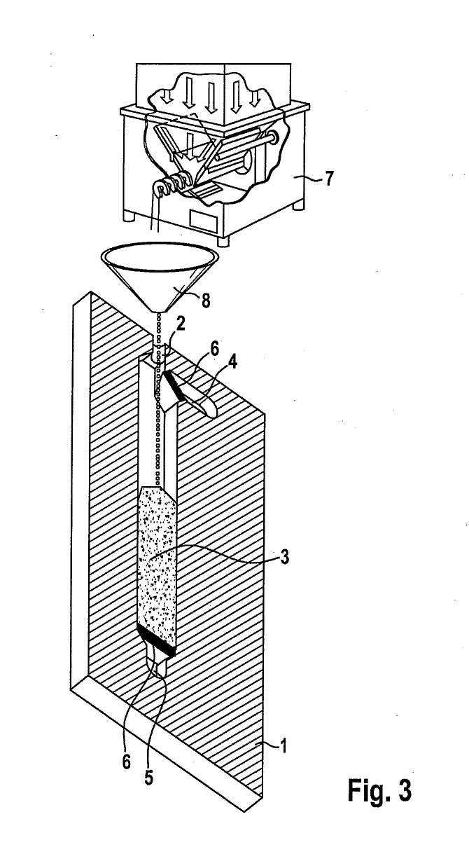

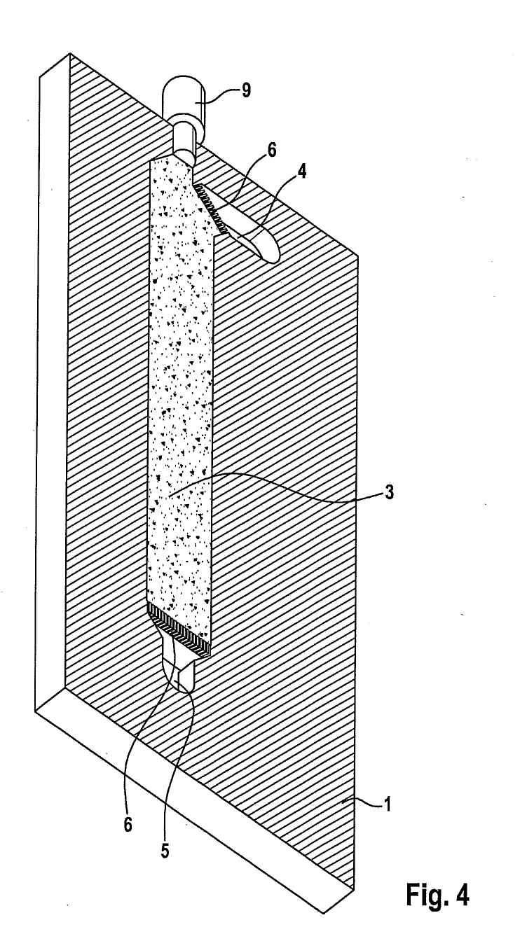

FIG. 3 shows a schematic representation of the filling of a chromatography element 1 standing on its side. Using a metering device 7, for example, a screw feeder, the stationary phase is introduced into cavity 3 via a funnel 8 and filling opening 2. Retaining structures 6 prevent the spread of the stationary phase into fluid inlet 4 and fluid outlet 5 of the mobile phase. The fill may also be compacted by vibrating chromatography element 1. Filling opening 2 is subsequently squeezed using a hot stamp. Subsequently, microfluidic chromatography element 1 may be integrated into a microfluidic system. The mobile phase is fed via fluid inlet 4, the mobile phase perfusing the stationary phase laterally and subsequently exiting the column in fractions via fluid outlet 6.

FIG. 4 shows a microfluidic chromatography element 1 filled with the stationary phase, chromatography element 1 being closed and sealed using a stopper 9. Filling opening 2 is adjoined by cavity 3 filled with the stationary phase. Fluid inlet 4 and fluid outlet 5 are delimited from cavity 3 by retaining structures 6. All components for accommodating the mobile and the stationary phase are in one plane, which is only interrupted by retaining structures 6.

1-12. (canceled)

13. A microfluidic chromatography element, comprising:
a filling opening for filling with a stationary phase;
a cavity adjoining the filling opening for accommodating the stationary phase;
at least one fluid inlet for a mobile phase;
at least one fluid outlet for fractions of the mobile phase; and
retaining structures for the stationary phase situated in the fluid inlet and the fluid outlet;
wherein all components are situated in one plane and the mobile phase perfuses the stationary phase laterally.

14. The microfluidic chromatography element of claim 13, wherein the components are situated in one plane of a structured element.

15. The microfluidic chromatography element of claim 14, wherein the structured element has a flat seated, tight fitting cover.

16. The microfluidic chromatography element of claim 13, wherein the retaining structures have teeth, gaps, slots, pores and/or perforations, the openings of which are smaller than the smallest particles of the stationary phase.

17. The microfluidic chromatography element of claim 13, wherein the retaining structures are micro-milled, stamped, injection-molded, ablated from polymers with the aid of a laser or 3D-lithographed, rendered porous or are porous.

18. The microfluidic chromatography element of claim 13, wherein the stationary phase includes inorganic materials and is present in the form of particles, powder, gel, fibers and/or pellets having an angle of repose adapted to the boundaries of the cavity.

19. The microfluidic chromatography element of claim 13, wherein the stationary phase includes organic materials and is present in the form of particles, powder, gel, fibers and/or pellets having an angle of repose adapted to the boundaries of the cavity.

20. The microfluidic chromatography element of claim 18, wherein biochemical components presented on the surface of bacteriophages are coupled to the stationary phase.

21. The microfluidic chromatography element of claim 18, wherein the angle formed by the boundary of the cavity and a cross section of the filling opening is larger than or equal to the angle of repose of the stationary phase.

22. The microfluidic chromatography element of claim 13, wherein the filling opening is formed as a short channel structure in relation to the cavity.

23. The microfluidic chromatography element of claim 13, wherein the filling opening is sealed after filling by adhesive bonding using a hot stamp, laser welding, or a mechanical sealing arrangement.

24. The microfluidic chromatography element of claim 13, wherein the stationary phase is includes one of silicon dioxide, aluminum oxide, titanium oxide or zeolite and is present in the form of particles, powder, gel, fibers and/or pellets having an angle of repose adapted to the boundaries of the cavity.

25. The microfluidic chromatography element of claim 13, wherein the stationary phase includes biopolymers and is present in the form of particles, powder, gel, fibers and/or pellets having an angle of repose adapted to the boundaries of the cavity.

26. The microfluidic chromatography element of claim 13, wherein the stationary phase includes cross-linked agaroses and is present in the form of particles, powder, gel, fibers and/or pellets having an angle of repose adapted to the boundaries of the cavity.

27. The microfluidic chromatography element of claim 18, wherein biochemical components, including one of recombinant libraries of antibodies, enzymes or proteins presented on the surface of bacteriophages are coupled to the stationary phase.

28. The microfluidic chromatography element of claim 13, wherein the filling opening is sealed after filling by adhesive bonding, including using adhesive film, hot-melt adhesive or liquid adhesive, heat-sealing, including using a hot stamp, laser welding, or mechanical sealing arrangement, including using a plug or a stopper.

29. A pressure-driven microfluidic system for purification, separation and/or as part of ion exchange processes, comprising:
a microfluidic chromatography element, including:
a filling opening for filling with a stationary phase;
a cavity adjoining the filling opening for accommodating the stationary phase;
at least one fluid inlet for a mobile phase;
at least one fluid outlet for fractions of the mobile phase; and
retaining structures for the stationary phase situated in the fluid inlet and the fluid outlet;
wherein all components are situated in one plane and the mobile phase perfuses the stationary phase laterally.

30. The pressure-driven microfluidic system of claim 29, wherein the system includes a micro total analysis system.

31. A centrifugally driven microfluidic system for purification, separation and/or as part of ion exchange processes, comprising:
a microfluidic chromatography element, including:
a filling opening for filling with a stationary phase;
a cavity adjoining the filling opening for accommodating the stationary phase;
at least one fluid inlet for a mobile phase;
at least one fluid outlet for fractions of the mobile phase; and
retaining structures for the stationary phase situated in the fluid inlet and the fluid outlet;
wherein all components are situated in one plane and the mobile phase perfuses the stationary phase laterally.

32. The centrifugally driven microfluidic system of claim 29, wherein the system includes a micro total analysis system.
